(19) United States
(12) Patent Application Publication
(10) Pub. No.: US 2024/0387954 A1
(43) Pub. Date: Nov. 21, 2024

(54) LITHIUM BATTERY, CELL AND CELL REPLACING METHOD THEREOF

(71) Applicant: AMITA TECHNOLOGIES INC., Taoyuan City (TW)

(72) Inventors: Yuan-Li CHIANG, Taoyuan City (TW); Yi-Cheng CHEN, Taoyuan City (TW)

(21) Appl. No.: 18/225,280

(22) Filed: Jul. 24, 2023

(30) Foreign Application Priority Data
May 15, 2023 (TW) 112117948

(51) Int. Cl. H01M 50/516; B23K 1/00; H01M 10/42; H01M 50/105; H01M 50/178; H01M 50/55; H01M 50/557; H01M 50/562

(52) U.S. Cl. CPC H01M 50/516; B23K 1/0016; H01M 10/42; H01M 50/105; H01M 50/178; H01M 50/55; H01M 50/557; H01M 50/562

(57) ABSTRACT

A lithium battery includes multiple cells. Each cell includes a body and a pair of electrode tabs. In each cell, the pair of electrode tabs is arranged on one side of the body. Each electrode tab is outwardly extended from the body. Each electrode tab includes a first conductive sheet and at least one second conductive sheet, which are arranged side by side. In each cell, each electrode tab is soldered with a corresponding electrode tab of another cell, the first conductive sheets and the second conductive sheets of the two electrode tabs correspondingly soldered with each other are arranged in pairs, and only the two first conductive sheets are correspondingly soldered with each other.

### BACKGROUND

### Technical Field

The disclosure relates to a lithium battery, particularly to a lithium battery that and a cell thereof, which are easy to be repeatedly assembled.

### Related Art

With the development of lithium battery technology becoming more and more mature, lithium batteries are also widely used in many fields in daily life. Generally speaking, a large lithium battery is formed by stacking multiple cells, and the electrode tabs of the cells are soldered to each other to form a series or parallel power supply circuit. After the assembly of the cells of a general large-scale lithium battery is completed, once a malfunction is found during testing, the electrode tabs of the malfunctioned cell and the cell soldered therewith must be peeled off and re-soldered with a new cell. The procedure of stripping the soldering joints of the electrode tabs is quite time consuming. And it is easy to damage the electrode tabs of normal cells when peeling off the electrode tabs, so that the quality of the soldering joints after re-soldering the new cell is poor, and even the normal cells are damaged to the point where they need to be replaced.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

The disclosure provides both a lithium battery and a cell thereof that are easy to be repeatedly assembled.

The disclosure provides a lithium battery, which includes multiple cells. Each cell includes a body and a pair of electrode tabs. In each cell, the pair of electrode tabs is arranged on one side of the body. Each electrode tab is outwardly extended from the body. Each electrode tab includes a first conductive sheet and at least one second conductive sheet, which are arranged side by side. In each cell, each electrode tab is soldered with a corresponding electrode tab of another cell, the first conductive sheets and the second conductive sheets of the two electrode tabs correspondingly soldered with each other are respectively arranged in pair, and only the first conductive sheets are correspondingly soldered with each other.

In an embodiment of the disclosure, in each cell, the pair of electrode tabs is a positive tab and a negative tab. The positive tab is made of aluminum, and the negative tab is made of copper.

In an embodiment of the disclosure, the body includes an outer bag and multiple electrode sheets stacked and received in the outer bag, and each electrode tab connects with part of the corresponding electrode sheet and penetrates the outer bag. Each electrode tab includes a root portion, the first conductive sheet and the at least one second conductive sheet of the electrode tab separately connect with the root portion, and the root portion projects from the outer bag.

The disclosure provides a cell, which includes a body and a pair of electrode tabs. The electrode tabs are arranged on one side of the body. Each electrode tab is outwardly extended from the body. Each electrode tab includes a first conductive sheet and a second conductive sheet arranged side by side.

In an embodiment of the disclosure, the pair of electrode tabs is a positive tab and a negative tab. The positive tab is made of aluminum, and the negative tab is made of copper.

In an embodiment of the disclosure, the body includes an outer bag and multiple electrode sheets stacked and received in the outer bag, and each electrode tab connects with part of the corresponding electrode sheet and penetrates the outer bag. Each electrode tab includes a root portion, the first conductive sheet and the at least one second conductive sheet of the electrode tab separately connect with the root portion, and the root portion projects from the outer bag.

The disclosure provides a method for replacing a cell of lithium battery, which includes the steps of: a) providing a lithium battery, wherein the lithium battery includes multiple cells which are stacked, each cell includes a body and a pair of electrode tabs arranged on one side of the body, and each electrode tab is outwardly extended from the body, each electrode tab includes a first conductive sheet and at least one second conductive sheet, which are arranged side by side, in each cell, each electrode tab is soldered with a corresponding electrode tab of another cell, the two first conductive sheets and the second conductive sheets of the two electrode tabs correspondingly soldered with each other are arranged in pairs, only the two first conductive sheets are correspondingly soldered with each other, and one of the cells malfunctions: b) cutting off a connection of the first conductive sheet of the malfunctioned cell and another first conductive sheet which is soldered therewith: c) providing a replacement cell; d) replacing the malfunctioned cell with the replacement cell; and e) soldering the at least one second conductive sheet of the electrode tab separated from the malfunctioned cell with the replacement cell.

In the lithium battery and the cell thereof in the disclosure, each electrode tab has the first conductive sheet and the second conductive sheet, so the first conductive sheet may be directly cut off, and the second conductive sheet is substitutively used to be soldered when reworking. This may avoid repeatedly soldering at the same soldering point to cause poor soldering quality, and does not need to peel off the soldering point. As a result, the lithium battery of the disclosure and the cell thereof are easy to be reassembled.

### BRIEF DESCRIPTION THE DRAWINGS

FIG. 1 is a perspective schematic view of the cell of an embodiment of the disclosure:

FIG. 2 is a schematic view of the cell and the electrode tab of an embodiment of the disclosure:

FIGS. 3-6 are schematic views of the assembling steps of the lithium battery of an embodiment of the disclosure:

FIG. 7 is a schematic view of the disassembling steps of the malfunctioned cell of the lithium battery of an embodiment of the disclosure

FIGS. 8-9 are schematic views of the cell replacing steps of the lithium battery of an embodiment of the disclosure; and

FIG. 10 is a flowchart of the cell disassembling and replacing steps of the lithium battery of an embodiment of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

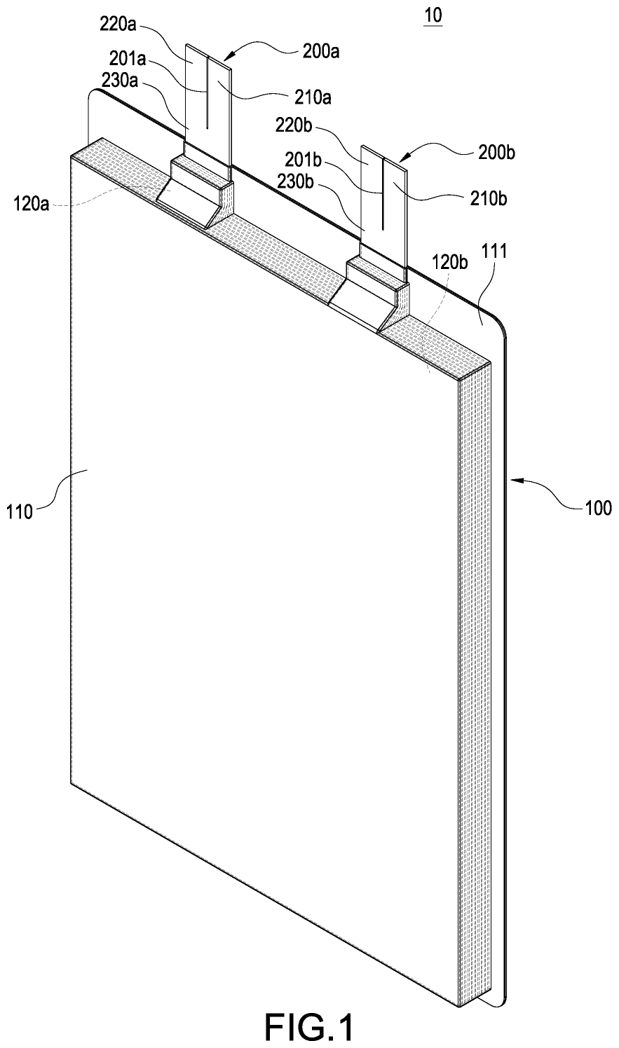

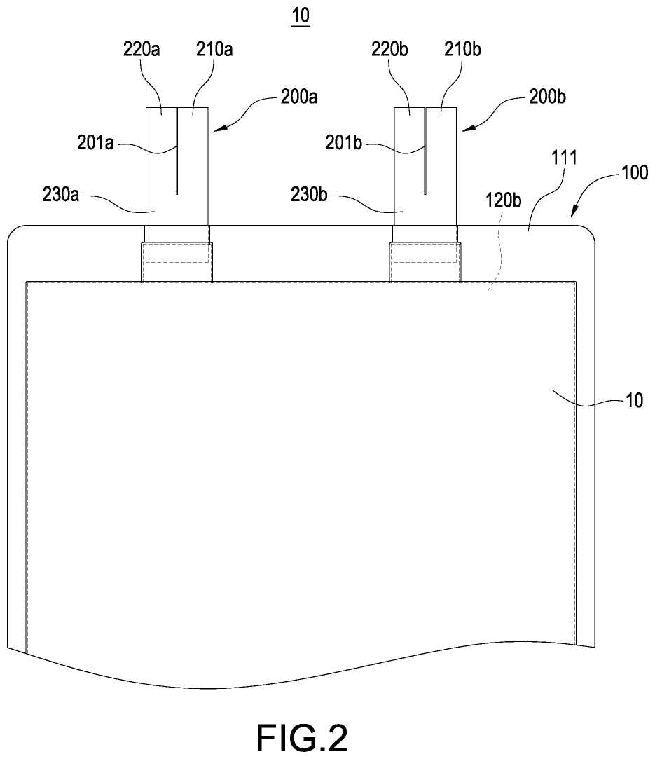

Please refer to FIGS. 1 and 2. The disclosure provides a cell 10, which includes a body 100 and a pair of electrode tabs.

The body 100 includes an outer bag 110 and multiple electrode sheets stacked and received in the outer bag 110. The electrode sheets include at least one positive sheet 120a and at least one negative sheet 120b. The positive sheets 120a and the negative sheets 120b are alternately stacked. The positive sheets 120a and the negative sheets 120b are separately made of different materials to form a potential difference therebetween. In the embodiment, the multiple electrode sheets include multiple positive sheets 120a and multiple negative sheets 120b, and the positive sheets 120a are made of aluminum and the negative sheets 120b are made of copper.

The electrode tab is connected with part of the multiple electrode sheets and protrudes through the outer bag 110. In the embodiment, the cell 10 includes a pair of electrode tabs, one is a positive tab 200a and the other one is a negative tab 200b. The positive tab 200a is made of aluminum and connected with the positive sheets 120a. The negative tab 200b is made of copper and connected with the negative sheets 120b. Each electrode tab is arranged on one side of the body 100 and is outwardly extended from the body 100. The two electrode tabs may be disposed on the same side or different sides of the body 100, but not limited to this.

A distal end of each electrode tab is disposed with an incision 201a/201b. Each incision 201a/201b separately extends along a longitudinal direction of each electrode tab to separately form a first conductive sheet 210a/210b and at least one second conductive sheet 220a/220b on each electrode tab, which are arranged side by side. In detail, the length direction of each electrode tab is the longitudinal direction of each electrode tab. The number of the incision 201a/201b may be added to form additional second conductive sheets 220a/220b depending upon the requirement of the amount of the second conductive sheets 220a/220b.

Each electrode tab of the embodiment has a root portion 230a/230b. The first conductive sheet 210a/210b and the second conductive sheet 220a/220b of the electrode tab are separately connected with the root portion 230a/230b to extend to a distal end of the electrode tab. The outer bag 110 has a sealed edge 111. The root portion 230a/230b of the electrode tab penetrates the sealed edge 111 to project from the outer bag 110 to prevent an end of the incision 201a/201b from being located in the sealed edge 111 to cause airtight failure of the outer bag 110.

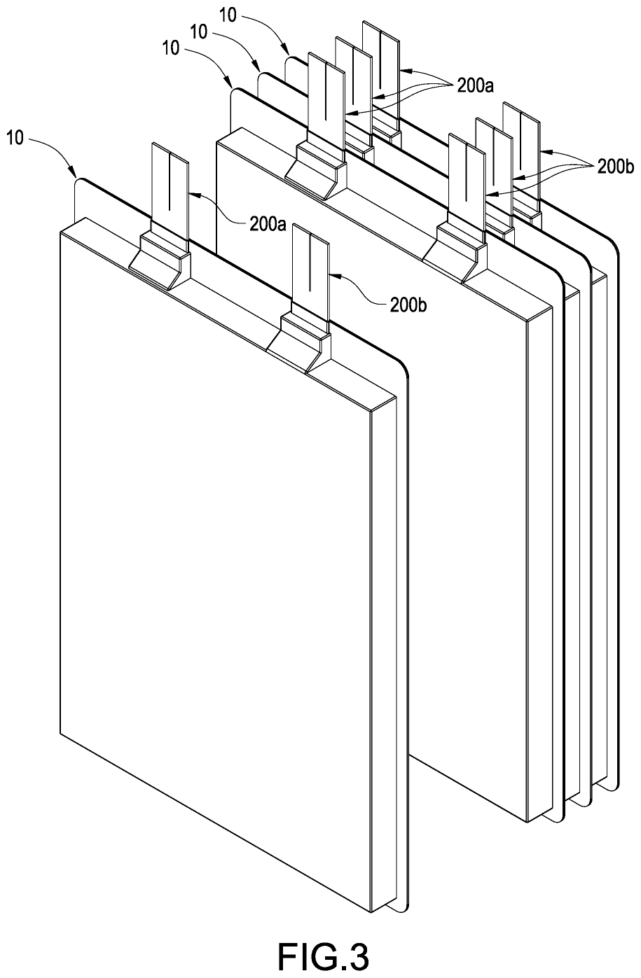

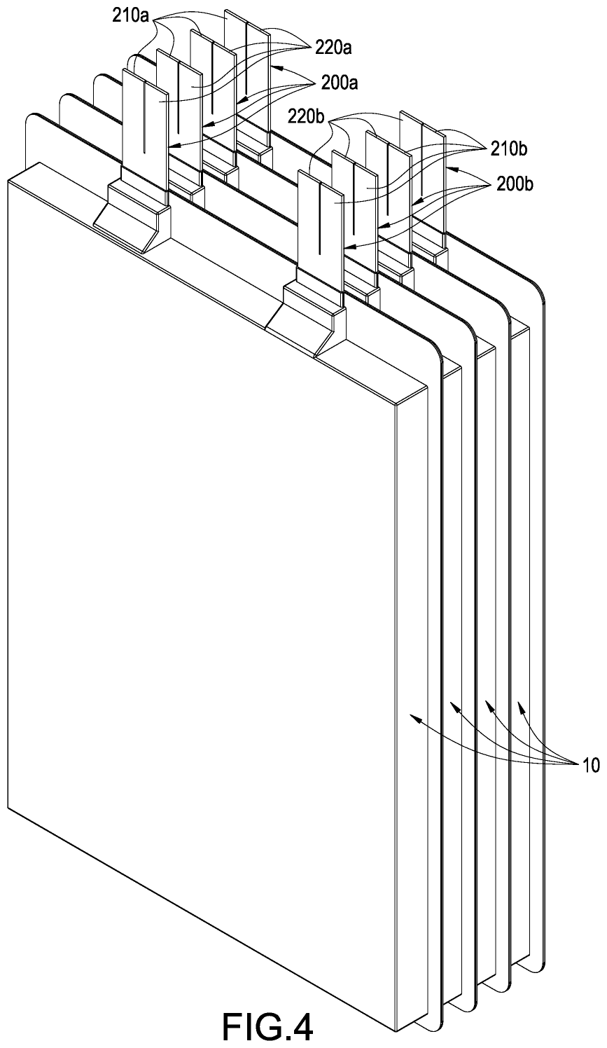

Please refer to FIGS. 3-6. The disclosure provides a lithium battery, which includes multiple cells 10. Please refer to FIGS. 3 and 4. Each cell 10 includes a body 100 and a pair of electrode tabs. In each cell 10, the pair of electrode tabs is a positive tab 200a and a negative tab 200b. The pair of electrode tabs is arranged on one side of the body 100. Each electrode tab is outward extended from the body 100. Each electrode tab includes a first conductive sheet 210a/210b and a second conductive sheet 220a/220b, which are arranged side by side.

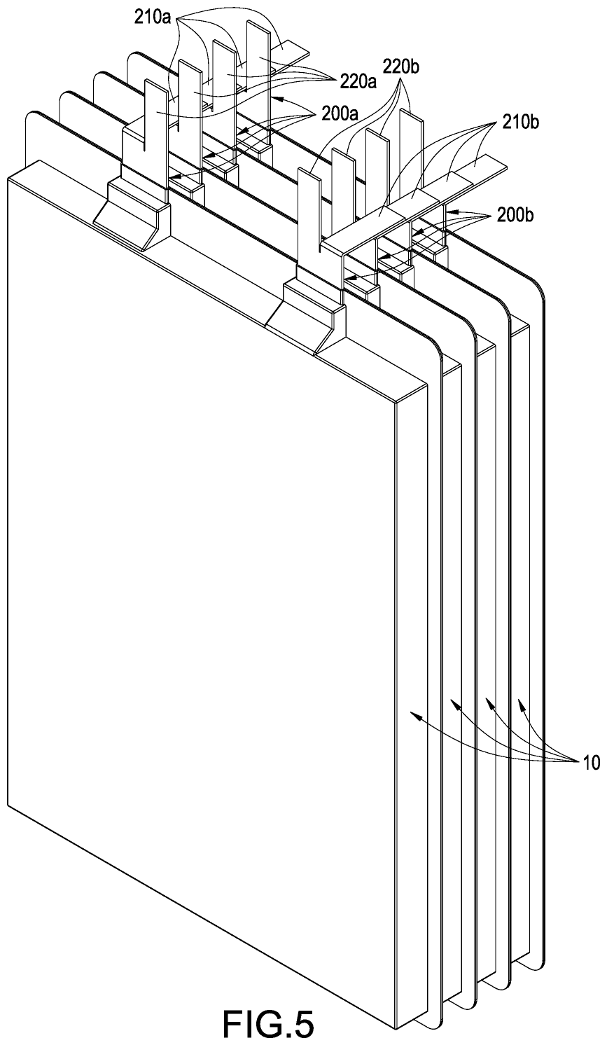

Please refer to FIG. 5. In each cell 10, each electrode tab is soldered with a corresponding electrode tab of another cell 10. The two first conductive sheets 210a/210b and the two second conductive sheets 220a/220b of the two electrode tabs are arranged correspondingly. In the embodiment, they align with each other, but not limited to this. Also, in the two electrode tabs which are correspondingly soldered with each other, only the two first conductive sheets 210a/210b are correspondingly soldered with each other.

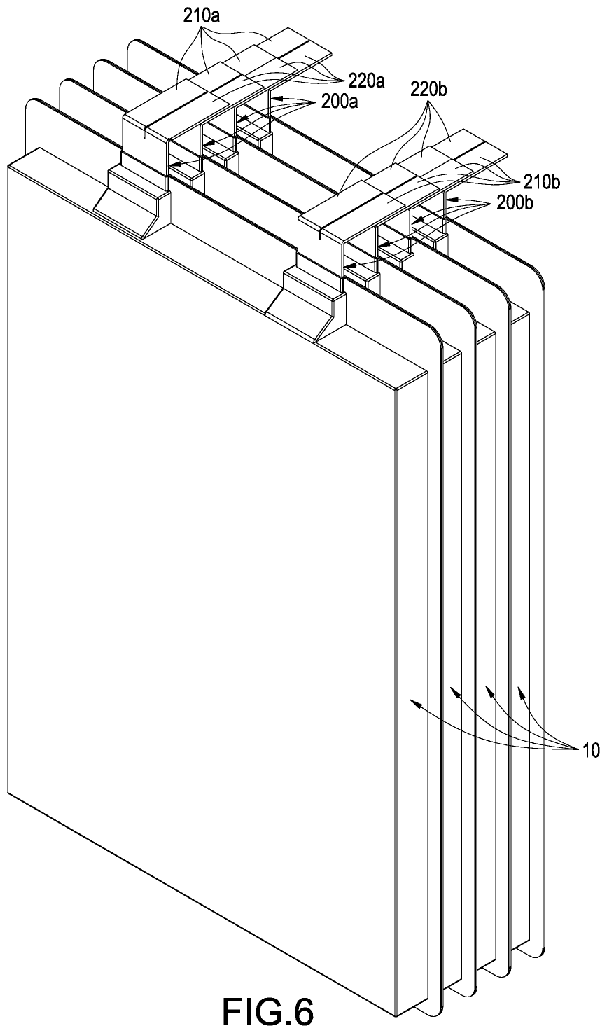

Please refer to FIG. 6. In the embodiment, when assembling the lithium battery, the two first conductive sheets 210a/210b of the two electrode tabs, which are correspondingly soldered with each other, are separately bent to overlap and be soldered with each other, and the two second conductive sheets 220a/220b of the two electrode tabs, which are correspondingly soldered with each other, are separately bent to overlap but not to be soldered.

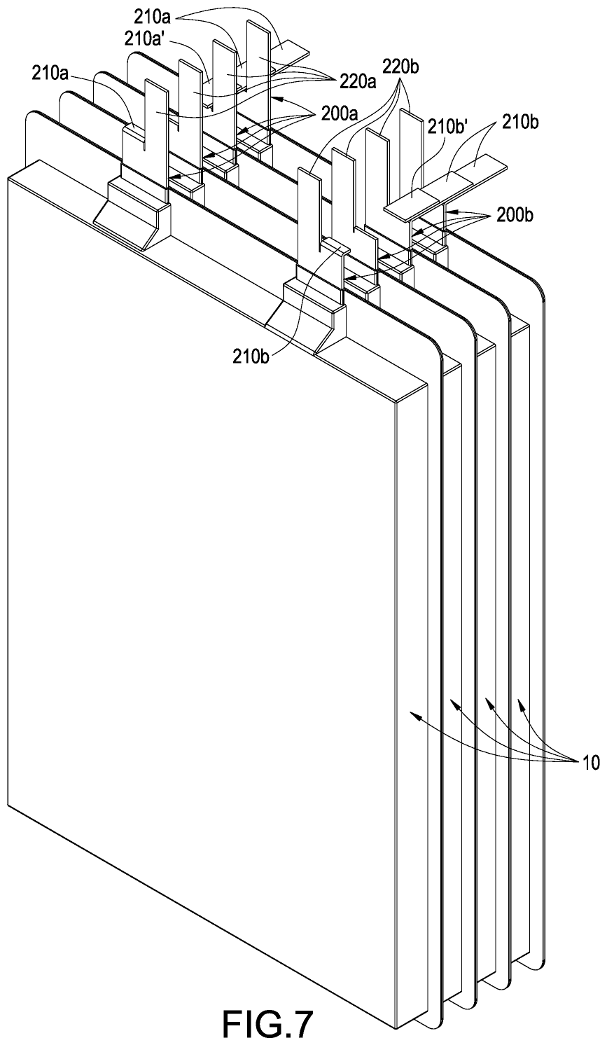

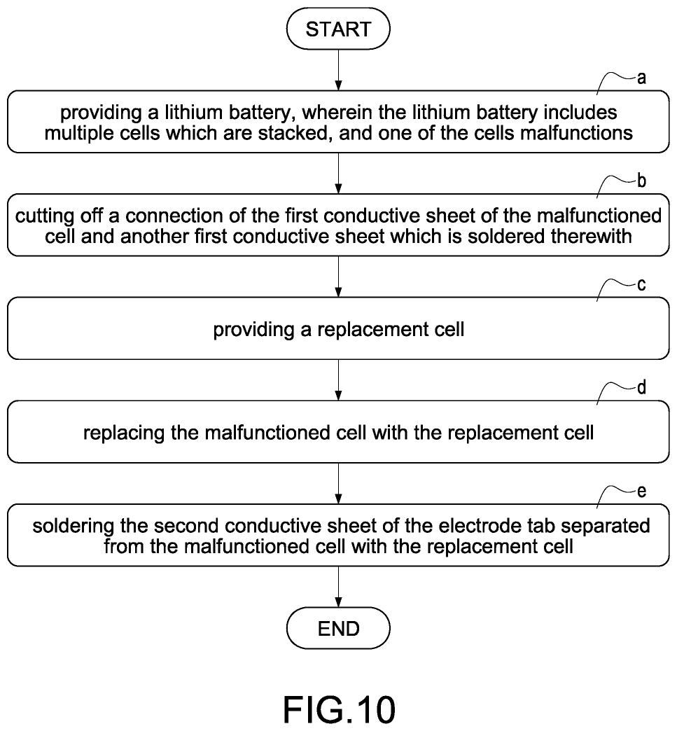

Please refer to FIGS. 7 and 10. When an assembled lithium battery is detected to be that one cell 10′ of the stacked cell 10, 10′ is malfunctioned, the steps of the cell disassembling and replacing method of the lithium battery of the disclosure are described below.

First, in step a, providing a lithium battery as abovementioned, and one cell 10′ of the stacked cells 10, 10′ being malfunctioned.

Next to step a, in step b, cutting off a connection of the first conductive sheet 210a′, 210b″ of the malfunctioned cell 10′ and the first conductive sheet 210a, 210b of the adjacent cell 10 which is soldered therewith to remove the malfunctioned cell 10′. In the embodiment, the first conductive sheet 210a′, 210b′ of the malfunctioned cell 10′ is cut off and stayed on the first conductive sheet 210a, 210b of the normal cell 10 which is soldered therewith.

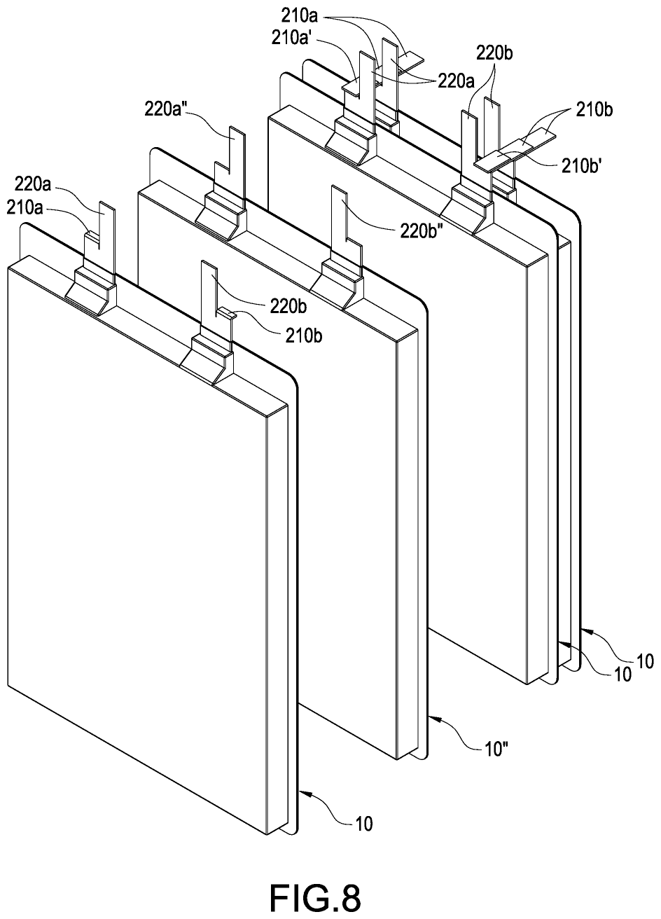

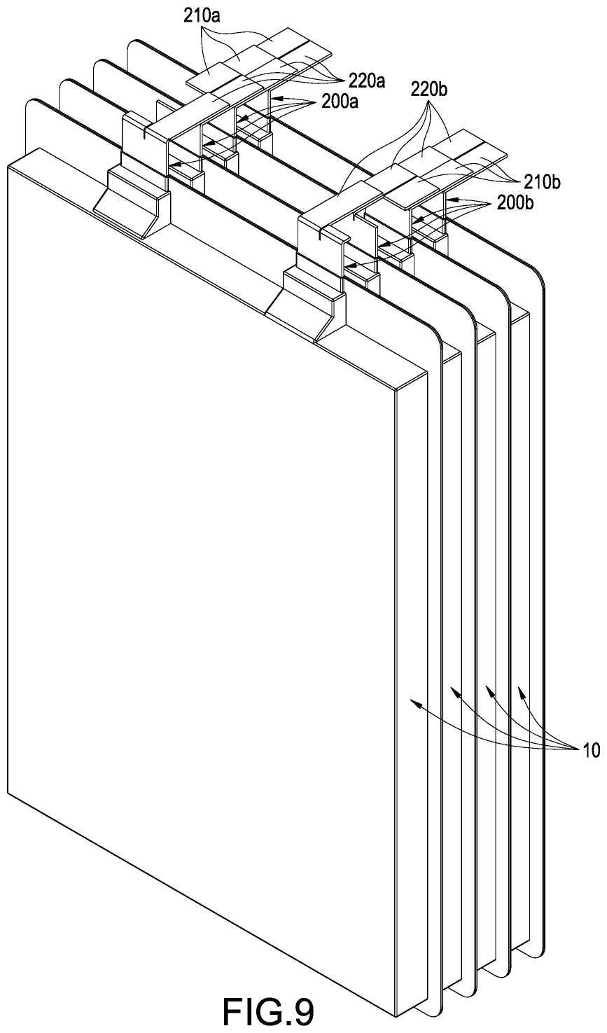

Please refer to FIGS. 8-10. Next to step b, in step c, providing a replacement cell 10″. The replacement cell 10″ is the same as the other cells 10 in structure. In other words, the replacement cell 10″ also includes a pair of electrodes, and each electrode includes a first conductive sheet 210a″/210b″ and at least one second conductive sheet 220a″/220b″, which are arranged side by side.

Next to step c, in step d, replacing the malfunctioned cell 10′ with the replacement cell 10″.

Next to step d, in step e, soldering the second conductive sheet 220a″, 220b″ of the replacement cell 10″ with the second conductive sheet 220a, 220b of the adjacent cell 10 to finish the reassembling.

In the lithium battery of the disclosure and the cell 10 thereof, each electrode tab has the first conductive sheet 210a, 210b and the second conductive sheet 220a, 220b, so the first conductive sheet 210a, 210b may be directly cut off and the second conductive sheet 220a, 220b is substitutively used to be soldered when reworking. This may avoid repeatedly soldering at the same soldering point to cause poor soldering quality, and does not need to peel off the soldering point. As a result, the lithium battery and the cell 10 thereof of the disclosure are easy to be reassembled. Also, the first conductive sheet 210a, 210b and the second conductive sheet 220a, 220b may be formed only by making the incision 201a/201b on each electrode tab.

While this disclosure has been described by means of specific embodiments, numerous modifications and variations could be made thereto by those skilled in the art without departing from the scope and spirit of this disclosure set forth in the claims.

What is claimed is:

1. A lithium battery comprising:
multiple cells, stacked with each other, each cell comprising a body and a pair of electrode tabs arranged on one side of the body, and each electrode tab outwardly extended from the body;
wherein each electrode tab comprises a first conductive sheet and at least one second conductive sheet arranged side by side, in each cell, each electrode tab is soldered with a corresponding electrode tab in another cell, multiple first conductive sheets and multiple second conductive sheets of two electrode tabs correspondingly soldered with each other are respectively arranged in pair, and only the first conductive sheets are correspondingly soldered with each other.

2. The lithium battery of claim 1, wherein in each cell, the pair of electrode tabs is a positive tab and a negative tab.

3. The lithium battery of claim 2, wherein the positive tab is made of aluminum, and the negative tab is made of copper.

4. The lithium battery of claim 1, wherein the body comprises an outer bag and multiple electrode sheets stacked and received in the outer bag, and each electrode tab connects with a part of the corresponding electrode sheet and penetrates the outer bag.

5. The lithium battery of claim 4, wherein each electrode tab comprises a root portion, the first conductive sheet and the at least one second conductive sheet of the electrode tab separately connect with the root portion, and the root portion projects from the outer bag.

6. A cell comprising:
a body; and
a pair of electrode tabs, arranged on one side of the body, and each electrode tab outwardly extended from the body;
wherein each electrode tab comprises a first conductive sheet and at least one second conductive sheet arranged side by side.

7. The cell of claim 6, wherein the pair of electrode tabs is a positive tab and a negative tab.

8. The cell of claim 7, wherein the positive tab is made of aluminum, and the negative tab is made of copper.

9. The cell of claim 6, wherein the body comprises an outer bag and multiple electrode sheets stacked and received in the outer bag, and each electrode tab connects with a part of the corresponding electrode sheet and penetrates the outer bag.

10. The cell of claim 9, wherein each electrode tab comprises a root portion, the first conductive sheet and the at least one second conductive sheet of the electrode tab separately connect with the root portion, and the root portion projects from the outer bag.

11. A method for replacing a cell of lithium battery, comprising:
a) providing a lithium battery, wherein the lithium battery includes multiple cells which are stacked, each cell comprises a body and a pair of electrode tabs arranged on one side of the body, and each electrode tab is outwardly extended from the body, each electrode tab comprises a first conductive sheet and at least one second conductive sheet, which are arranged side by side, in each cell, each electrode tab is soldered with a corresponding electrode tab of another cell, two first conductive sheets and the second conductive sheets of two electrode tabs correspondingly soldered with each other are arranged in pairs, only the two first conductive sheets are correspondingly soldered with each other, and one of the cells malfunctions;
b) cutting off a connection of the first conductive sheet of a malfunctioned cell and another first conductive sheet which is soldered therewith;
c) providing a replacement cell;
d) replacing the malfunctioned cell with the replacement cell; and
e) soldering the at least one second conductive sheet of the electrode tab separated from the malfunctioned cell with the replacement cell.
